(19) United States
(12) Patent Application Publication
(10) Pub. No.: US 2023/0245250 A1
(43) Pub. Date: Aug. 3, 2023

(54) CHARGING MANAGEMENT METHODS AND SYSTEMS FOR ELECTRIC VEHICLES

(71) Applicant: Noodoe Corporation, Taipei City (TW)

(72) Inventors: YU-TING LIOU, Taipei City (TW); CHIA-WEI HU, Taipei City (TW); YIN-JU CHOU, Taipei City (TW); YAN-MING CHEN, Taipei City (TW)

(21) Appl. No.: 18/058,886

(22) Filed: Nov. 28, 2022

(30) Foreign Application Priority Data
Jan. 28, 2022 (TW) 111103804

(51) Int. Cl. G06Q 50/06; B60L 53/68; G06Q 30/04

(52) U.S. Cl. CPC G06Q 50/06; B60L 53/68; G06Q 30/04

(57) ABSTRACT

Charging management methods and systems for electric vehicles are provided. First, a server receives a charging request from an electric vehicle charging station or a mobile device via a network. In response to the charging request, the server transmits a charging start instruction to the electric vehicle charging station via the network, and the electric vehicle charging station performs a charging operation to output power to an electric vehicle. The server enables the mobile device to have the ability to stop charging. The server determines whether the electric vehicle charging station stops outputting power to the electric vehicle. When the electric vehicle charging station stops outputting power to the electric vehicle, the server disables the ability of stop charging of the mobile device.

### BACKGROUND OF THE INVENTION

### Field of the Invention

The disclosure relates generally to charging management methods and systems for electric vehicles, and, more particularly to methods and systems that can flexibly enable specific functions of the charging operation according to the state of the charging operation.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Generally, the construction of electric vehicle charging stations requires high costs, so the operators of electric vehicle charging stations usually hope to increase the utilization rate of electric vehicle charging stations, so as to pursue profits. In the current charging situation, it often happens that the owner of the electric vehicle may delay in unplugging the charging gun and forget to drive the electric vehicle away after the charging of the electric vehicle is completed. In view of this situation, some operators of electric vehicle charging stations will define an occupancy fee to charge the electric vehicle owner when the electric vehicle owner finishes charging but does not unplug the charging gun.

On the other hand, in order to provide a more friendly electric vehicle charging experience, many operators of electric vehicle charging stations have developed applications on mobile phones that allow users to search for electric vehicle charging stations, start charging, stop charging, and view charging progress and other functions. These apps really bring the electronic vehicle owners a more convenient and user-friendly charging experience. However, in the current situation, it often happens that after the user stops charging through the app, he/she does not actually arrive at the site to unplug the charging gun and drive away from the electric vehicle. The aforementioned phenomenon causes the charging station to be occupied, and the utilization rate cannot be increased, which in turn causes problems in the management of electric vehicle charging.

### BRIEF SUMMARY OF THE INVENTION

In a charging management method for electric vehicles for use in a server connected to at least one first charging station via a network, a charging request is first received from the electric vehicle charging station or a mobile device via the network by the server. In response to the charging request, a charging start instruction is transmitted to the electric vehicle charging station via the network by the server, and a charging operation is performed to output power to an electric vehicle in response to the charging start instruction by the electric vehicle charging station, wherein the electric vehicle is electrically coupled to the electric vehicle charging station. Next, the mobile device is enabled to have the ability to stop charging by the server. Then, it is determined whether the electric vehicle charging station stops outputting power to the electric vehicle by the server, and the ability of stop charging of the mobile device is disabled by the server when the electric vehicle charging station stops outputting power to the electric vehicle.

An embodiment of a charging management system for electric vehicles comprises at least one electric vehicle charging station and a server. The electric vehicle charging station is electrically coupled to an electric vehicle. The server is connected with the electric vehicle charging station via a network, and the server receives a charging request from the electric vehicle charging station or a mobile device via the network, in response to the charging request, transmits a charging start instruction to the electric vehicle charging station via the network, and the electric vehicle charging station performs a charging operation to output power to the electric vehicle in response to the charging start instruction, wherein the electric vehicle is electrically coupled to the electric vehicle charging station. The server enables the mobile device to have the ability to stop charging and determines whether the electric vehicle charging station stops outputting power to the electric vehicle, and the server disables the ability of stop charging of the mobile device when the electric vehicle charging station stops outputting power to the electric vehicle.

In some embodiments, the server further receives charging data corresponding to the charging operation from the electric vehicle charging station through the network, calculates a charging fee corresponding to the charging operation based on the charging data, determines whether the electric vehicle charging station has stopped being electrically coupled to the electric vehicle by the server, and calculates an occupancy fee and adds the occupancy fee to the charging fee when the electric vehicle charging station does not stop being electrically coupled to the electric vehicle.

In some embodiments, the server further generates billing information based on the charging fee and provides at least one payment mechanism to receive payment corresponding to the billing information when the electric vehicle charging station has stopped being electrically coupled to the electric vehicle.

In some embodiments, the server further receives a charging stop signal corresponding to stopping the charging operation from the mobile device through the network when the electric vehicle charging station does not stop outputting power to the electric vehicle, and in response to the charging stop signal, the server transmits a charging stop instruction to the electric vehicle charging station through the network, and the electric vehicle charging station stops the charging operation in response to the charging stop instruction.

In some embodiments, the server further receives charging data corresponding to the charging operation from the electric vehicle charging station through the network, and calculates a charging fee corresponding to the charging operation based on the charging data, and when the electric vehicle charging station stops the charging operation in response to the charging stop instruction, the server further sends a message to the mobile device through the network to notify that the charging operation has been stopped and will start counting an occupancy fee at a specific time point, determines whether the electric vehicle charging station has stopped being electrically coupled to the electric vehicle, and the server further calculates the occupancy fee and adds the occupancy fee to the charging fee when the electric vehicle charging station does not stop being electrically coupled to the electric vehicle.

In some embodiments, the server further generates billing information based on the charging fee and provides at least one payment mechanism to receive payment corresponding to the billing information when the electric vehicle charging station has stopped being electrically coupled to the electric vehicle.

In some embodiments, the server further enables the mobile device to have the ability to stop charging by sending a webpage link corresponding to the charging operation to the mobile device, and the webpage has a charging stop button, wherein when the charging stop button is being pressed, the charging operation is stopped.

In some embodiments, the server further enables the mobile device to have the ability to stop charging by providing a charging stop button through an application in the mobile device, wherein the application is used to check the progress of the charging operation, and when the charging stop button is being pressed, the charging operation is stopped.

In some embodiments, the charging data at least comprises a charging time and a charging amount of power corresponding to the charging operation.

Charging management methods for electric vehicles may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a charging management system for electric vehicles of the invention;

FIG. 2 is a schematic diagram illustrating an embodiment of an electric vehicle charging station of the invention;

FIG. 3 is a schematic diagram illustrating an embodiment of a server of the invention;

FIG. 4 is a flowchart of an embodiment of a charging management method for electric vehicles of the invention;

FIG. 5 is a flowchart of an embodiment of a method for enabling a mobile device to have the ability to stop charging of the invention;

FIG. 6 is a flowchart of another embodiment of a method for enabling a mobile device to have the ability to stop charging of the invention;

FIG. 7 is a flowchart of another embodiment of a charging management method for electric vehicles of the invention; and

FIG. 8 is a flowchart of another embodiment of a charging management method for electric vehicles of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

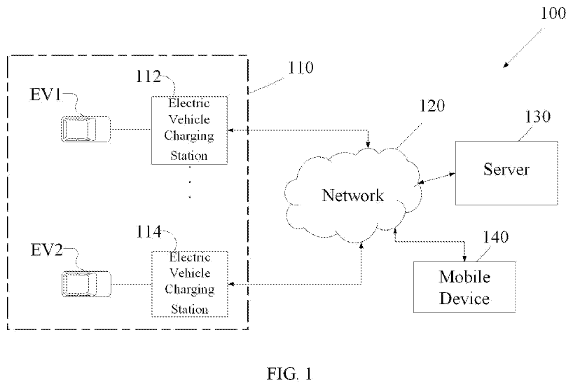

FIG. 1 is a schematic diagram illustrating an embodiment of a charging management system for electric vehicles of the invention. The charging management system for electric vehicles 100 comprises at least one electric vehicle charging station, such as electric vehicle charging stations (112, 114), and a server 130 respectively connected with respective charging station via a network 120. The respective charging stations can provide electric vehicles (EV1, EV2) for charging operations. In some embodiments, the network 120 may be a wired network, a telecommunication network, and a wireless network, such as a Wi-Fi network. The server 130 can respectively receive various data from the electric vehicle charging stations (112, 114), and transmit related signals to the electric vehicle charging stations (112, 114). The electric vehicle charging stations (112, 114) can perform related operations according to the signals received from the server 130. For example, when the electric vehicle EV1 is coupled to the electric vehicle charging station 112 through a charging gun of the first charging station 112 for a charging operation, the electric vehicle charging station 112 can continuously transmit charging information corresponding the charging operation of the electric vehicle EV1 via the network 120, and the server 130 can receive the charging information of the corresponding charging operation from the electric vehicle charging station 112 via the network 120. Similarly, when the electric vehicle EV2 is coupled to the electric vehicle charging station 114 through a charging gun of the electric vehicle charging station 114 to perform a charging operation, the electric vehicle charging station 114 can continuously transmit the charging information corresponding the charging operation of the electric vehicle EV2 via the network 120, and the server 130 can receive the charging information of the corresponding charging operation from the electric vehicle charging station 114 via the network 120. In some embodiments, the charging information may include at least a charging start time, a charging period, an output power, and/or related information indicating whether a load adjustment operation is being performed. The server 130 can know the usage status of the corresponding electric vehicle charging station according to the charging information.

It is noted that the user can connect the electric vehicle EV1 and the electric vehicle charging station 112 to each other, such as inserting a charging gun into the charging port of the electric vehicle to send a charging request corresponding to the electric vehicle charging station 112 to use the electric vehicle charging station 112 to perform a charging operation for the electric vehicle EV1. Similarly, the user can connect the electric vehicle EV2 and the electric vehicle charging station 114 to each other, such as inserting a charging gun into the charging port of the electric vehicle to send a charging request corresponding to the electric vehicle charging station 114 to use the electric vehicle charging station 114 to perform a charging operation for the electric vehicle EV2. It is understood that, in some embodiments, the server 130 may directly or indirectly receive a charging request from a mobile device 140 of the owner of the electric vehicle EV1, and generate a charging authorization command based on the charging request and transmit it to the electric vehicle charging station 112 via the network 120, so that the electric vehicle charging station 112 outputs power to the electric vehicle EV1, such as an electric scooter or an electric car, which is electrically connected to it, or prohibits the first charging station 112 from outputting power to the electric vehicle EV1. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the electric vehicle charging station 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use an RFID card to approach an induction area (not shown in FIG. 1) on the electric vehicle charging station 112 to generate a corresponding charging request, and sent it to the server 130 via the network 120. It is reminded that, in some embodiments, each user can have an RFID card.

It is noted that, the mobile device 140 may be corresponded to the owner of the electric vehicle, which can be any electronic device capable of Internet access, such as mobile devices, such as mobile phones, smart phones, personal digital assistants, global positioning systems, and notebook computers. In some embodiments, the mobile device 140 can receive status information and notifications of the corresponding charging operation from the cloud management server 130 via the network 120. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

It is understood that, in some embodiments, the server 130 can perform a load adjustment operation for the electric vehicle charging stations according to at least one energy management scheme. Specifically, the server 130 can generate an instruction and send the instruction to the respective electric vehicle charging stations (112, 114) via the network 120 to control the electric vehicle charging station to output power for charging with a specified power parameter, such as a specified amperage, during a specific period of time to the electric vehicle connected to the station, or to prohibit the electric vehicle charging station from outputting power to the electric vehicle. It should be noted that, in some embodiments, the server 130 can provide a reserved charging mechanism, and the mobile device 140 can set a specific electric vehicle charging station through the reserved charging mechanism to perform the reserved charging operation. Note that, through the reservation charging mechanism, the mobile device 140 can transmit a charging request including a reservation request to the server 130. The reservation request may include an identity identification information corresponding to the mobile device 140. The identity identification information can be used for subsequent identity authentication procedures when performing charging operations.

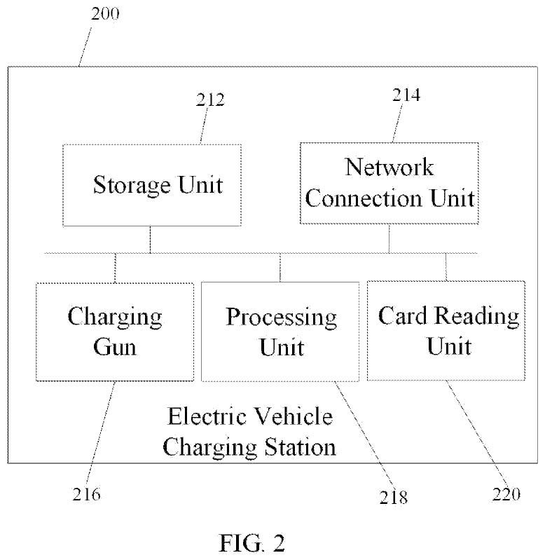

FIG. 2 is a schematic diagram illustrating an embodiment of an electric vehicle charging station of the invention. The electric vehicle charging station 200 shown in FIG. 2 can be applied to the electric vehicle charging stations (112, 114) in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, a processing unit 218, and a card reading unit 220. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The processing unit 218 can control the operations of related software and hardware in the electric vehicle charging station 200, and cooperate with the server 130 to execute the charging management method for electric vehicles of the invention. Related details will be described later. It is noted that, in some embodiments, the processing unit 218 may be a general-purpose controller, a Micro-Control Unit, MCU, or a Digital Signal Processor, DSP, etc., to provide functions of data analysis, processing and calculation, but the present invention is not limited to this. In one embodiment, the processing unit 218 may use the network connection unit 214 to transmit the power state of the corresponding electric vehicle through a network for a cloud management server, such as the cloud server 130, for subsequent charging management. In another embodiment, the processing unit 218 can obtain the power parameter of a charging operation from the server 130, determine the output power according to the power parameter received from the server 130, and output the power to at least one electric vehicle through the charging gun 216 to perform the charging operation. The card reading unit 220 may be an RFID reading unit for sensing information of a physical card, such as RFID card. The information sensed from the RFID card may be a card identification code of the physical card.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

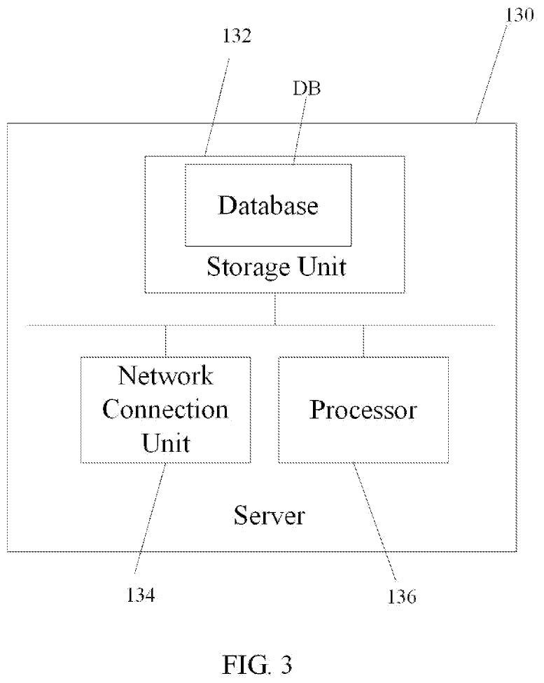

FIG. 3 is a schematic diagram illustrating an embodiment of a server of the invention. As shown in FIG. 3, the server 130 of the invention can be any processor-based electronic device, which comprises at least a storage unit 132, a network connection unit 134, and a processor 136. It is noted that, the server 130 can receive various data corresponding to a plurality of electric vehicle charging stations in a charging field. The server 130 can directly or indirectly receive a charging request from a mobile device, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 132 may be a memory comprising a database DB, which can store and record related data, such as various data of the electric vehicle charging stations. In addition, in some embodiments, the database DB may also record different users and corresponding user identification codes. Through the network connection unit 134, the server 130 can be coupled to and communicates with the electric vehicle charging stations (112, 114) via the network 120, such as a wired network, a telecommunications network, and a wireless network, such as a Wi-Fi network, and transmits related data/signals/commands to different electric vehicle charging stations via the network 120 to control whether the electric vehicle charging stations output power, and specify power parameters for outputting power to electric vehicles. The processor 136 can control the operations of related software and hardware in the server 130, and execute the charging management methods for electric vehicles of the invention. The relevant details will be described later. It is understood that, in some embodiments, the processor 136 may be a general-purpose controller, a Micro-Control Unit, MCU, or a Digital Signal Processor, DSP, etc., to provide data analysis, processing, and calculation functions.

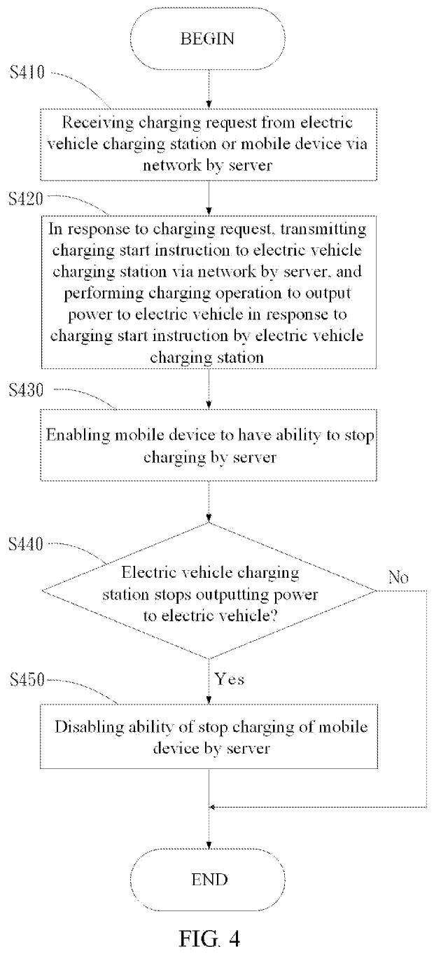

FIG. 4 is a flowchart of an embodiment of a charging management method for electric vehicles of the invention. The charging management method for electric vehicles of the invention is applicable to a server, at least one electric vehicle charging station connected to the server through a network, and a mobile device corresponding to an electric vehicle.

First, in step S410, the server receives a charging request from the electric vehicle charging station or the mobile device through the network. As mentioned above, in some embodiments, the user can connect the electric vehicle and the electric vehicle charging station to each other, such as inserting a charging gun into the charging port of the electric vehicle to send a charging request corresponding to the electric vehicle charging station. In some embodiments, the server may directly or indirectly receive a charging request from the mobile device of the owner of the electric vehicle. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle can use his/her mobile device to download and install an application to generate a charging request through the user interface of the application. In some embodiments, the user can scan a Quick Response Code (QR code) on the electric vehicle charging station through the scanning function of the application to generate the above-mentioned charging request. In some embodiments, the user can select a specific charging station through the application and execute an activation function to generate the above-mentioned charging request, thereby starting a charging operation. In some embodiments, the owner of the electric vehicle can use a physical card, such as an RFID card, to approach an induction area on the electric vehicle charging station to generate a corresponding charging request, and sent it to the server via the network. In step S420, in response to the charging request, the server transmits a charging start instruction/charging authorization instruction to the electric vehicle charging station via the network, such that the electric vehicle charging station performs a charging operation to output power to the electric vehicle, wherein the electric vehicle is electrically coupled to the electric vehicle charging station.

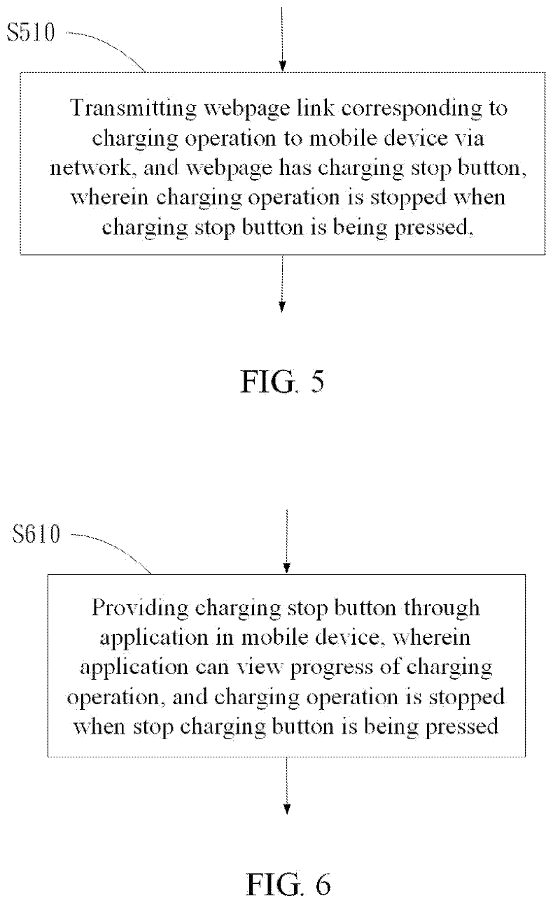

Next, in step S430, the server enables the mobile device to have the ability to stop charging. FIG. 5 is a flowchart of an embodiment of a method for enabling a mobile device to have the ability to stop charging of the invention. In this embodiment, in step S510, the server transmits a webpage link corresponding to the charging operation to the mobile device through the network. Note that the webpage has a charging stop button, wherein when the charging stop button is being pressed, the charging operation is stopped. FIG. 6 is a flowchart of another embodiment of a method for enabling a mobile device to have the ability to stop charging of the invention. In this embodiment, in step S610, the server provides a charging stop button through an application in the mobile device. The application can be used to view/check the progress of the charging operation, and when the stop charging button is being pressed, the charging operation is stopped. It should be noted that the above-mentioned mechanism by which the server enables the mobile device to stop the charging operation is only an example of the invention, and the present invention is not limited to any mechanism. Then, in step S440, the server determines whether the electric vehicle charging station stops outputting power to the electric vehicle. When the electric vehicle charging station does not stop outputting power to the electric vehicle (No in step S440), the process ends. When the electric vehicle charging station stops outputting power to the electric vehicle (Yes in step S440), in step S450, the server disables the ability of the mobile device to stop charging.

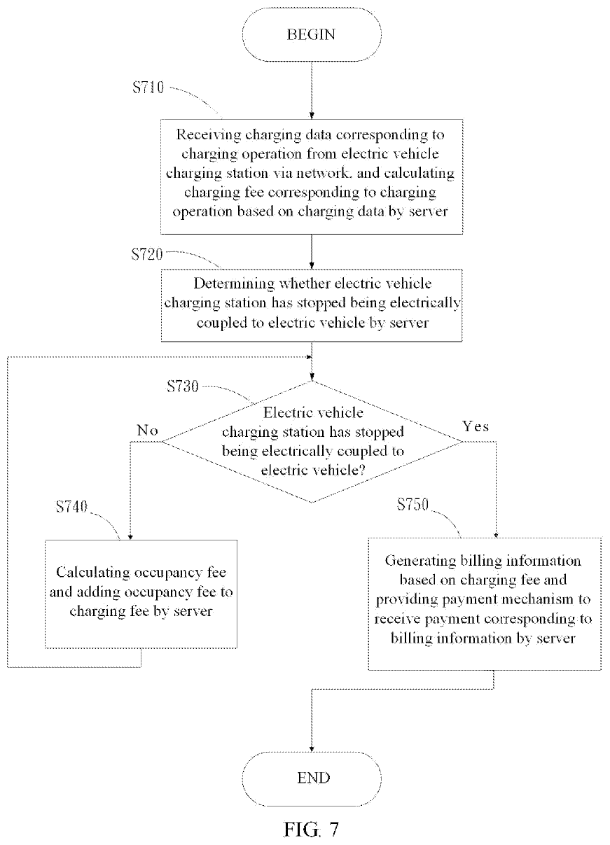

FIG. 7 is a flowchart of another embodiment of a charging management method for electric vehicles of the invention. In this embodiment, the corresponding charging fee can be calculated according to the coupling state of the electric vehicle charging station and the electric vehicle.

First, in step S710, the server receives charging data corresponding to the charging operation from the electric vehicle charging station through the network, and calculates a charging fee corresponding to the charging operation according to the charging data. It is reminded that, in some embodiments, the charging data at least includes a charging time and a charging amount of power corresponding to the charging operation. In step S720, the server determines whether the electric vehicle charging station has stopped being electrically coupled to the electric vehicle. When the electric vehicle charging station does not stop being electrically coupled to the electric vehicle (No in step S730), in step S740, the server calculates an occupancy fee and adds the occupancy fee to the charging fee. Thereafter, the determination in step S730 is continued. When the electric vehicle charging station has stopped being electrically coupled to the electric vehicle (Yes in step S730), in step S750, the server generates billing information based on the charging fee, and provides at least one payment mechanism to receive payment corresponding to the billing information.

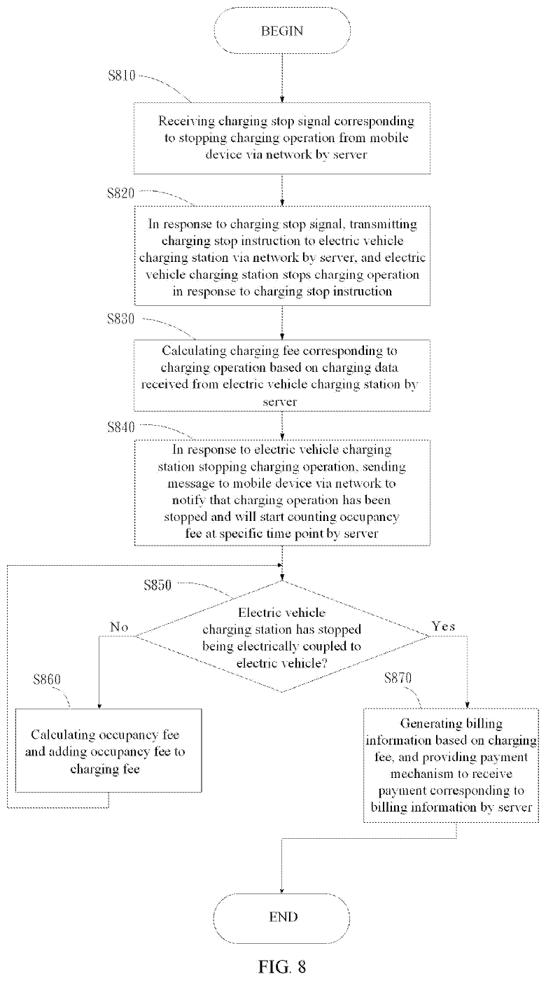

FIG. 8 is a flowchart of another embodiment of a charging management method for electric vehicles of the invention. In this embodiment, when the electric vehicle charging station does not stop outputting power to the electric vehicle, the user can actively stop the charging operation through the mobile device, and the corresponding charging fee can be calculated according to the coupling state of the electric vehicle charging station and the electric vehicle.

First, in step S810, the server receives a charging stop signal corresponding to stopping the charging operation from the mobile device through the network. In step S820, in response to the charging stop signal, the server transmits a charging stop instruction to the electric vehicle charging station through the network, and the electric vehicle charging station stops the charging operation in response to the charging stop instruction. Next, in step S830, the server calculates a charging fee corresponding to the charging operation based on the charging data corresponding to the charging operation received from the electric vehicle charging station. In step S840, in response to the electric vehicle charging station stopping the charging operation, the server sends a message to the mobile device through the network to notify that the charging operation has been stopped and will start counting an occupancy fee at a specific time point. Then, in step S850, the server determines whether the electric vehicle charging station has stopped being electrically coupled to the electric vehicle. When the electric vehicle charging station does not stop being electrically coupled to the electric vehicle (No in step S850), in step S860, the server calculates the occupancy fee and adds the occupancy fee to the charging fee. It is noted that, in some embodiments, the occupancy fee may be calculated based on occupancy time and a charging rate or a specific rate. Thereafter, the determination in step S850 is continued. When the electric vehicle charging station has stopped being electrically coupled to the electric vehicle (Yes in step S850), in step 5870, the server generates billing information based on the charging fee, and provides at least one payment mechanism to receive payment corresponding to the billing information.

Therefore, the charging management methods and systems for electric vehicles of the present invention can flexibly enable specific functions of the charging operation, such as the stop charging function on the mobile device, according to the state of the charging operation, and calculate the charging cost according to the coupling status between the electric vehicle charging station and the electric vehicle, thus increasing the efficiency and flexibility of the use and management of the electric vehicle charging station.

Charging management methods for electric vehicles, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A charging management method for electric vehicles for use in a server connected to at least one first charging station via a network, comprising:
receiving a charging request from the electric vehicle charging station or a mobile device via the network by the server;
in response to the charging request, transmitting a charging start instruction to the electric vehicle charging station via the network by the server, and performing a charging operation to output power to an electric vehicle in response to the charging start instruction by the electric vehicle charging station, wherein the electric vehicle is electrically coupled to the electric vehicle charging station;
enabling the mobile device to have the ability to stop charging by the server;
determining whether the electric vehicle charging station stops outputting power to the electric vehicle by the server; and
disabling the ability of stop charging of the mobile device by the server when the electric vehicle charging station stops outputting power to the electric vehicle.

2. The method of claim 1, further comprising:
receiving charging data corresponding to the charging operation from the electric vehicle charging station through the network, and calculating a charging fee corresponding to the charging operation based on the charging data by the server;
determining whether the electric vehicle charging station has stopped being electrically coupled to the electric vehicle by the server; and
calculating an occupancy fee and adding the occupancy fee to the charging fee by the server when the electric vehicle charging station does not stop being electrically coupled to the electric vehicle.

3. The method of claim 2, further comprising a step of generating billing information based on the charging fee and providing at least one payment mechanism to receive payment corresponding to the billing information by the server when the electric vehicle charging station has stopped being electrically coupled to the electric vehicle.

4. The method of claim 1, further comprising:
receiving a charging stop signal corresponding to stopping the charging operation from the mobile device through the network by the server when the electric vehicle charging station does not stop outputting power to the electric vehicle; and
in response to the charging stop signal, transmitting a charging stop instruction to the electric vehicle charging station through the network by the server, and the electric vehicle charging station stops the charging operation in response to the charging stop instruction.

5. The method of claim 4, further comprising:
receiving charging data corresponding to the charging operation from the electric vehicle charging station through the network, and calculating a charging fee corresponding to the charging operation based on the charging data by the server;
when the electric vehicle charging station stops the charging operation in response to the charging stop instruction, sending a message to the mobile device through the network to notify that the charging operation has been stopped and will start counting an occupancy fee at a specific time point by the server;
determining whether the electric vehicle charging station has stopped being electrically coupled to the electric vehicle by the server; and
calculating the occupancy fee and adding the occupancy fee to the charging fee by the server when the electric vehicle charging station does not stop being electrically coupled to the electric vehicle.

6. The method of claim 5, further comprising a step of generating billing information based on the charging fee and providing at least one payment mechanism to receive payment corresponding to the billing information by the server when the electric vehicle charging station has stopped being electrically coupled to the electric vehicle.

7. The method of claim 1, wherein the server enables the mobile device to have the ability to stop charging by sending a webpage link corresponding to the charging operation to the mobile device, and the webpage has a charging stop button, wherein when the charging stop button is being pressed, the charging operation is stopped.

8. The method of claim 1, wherein the server enables the mobile device to have the ability to stop charging by providing a charging stop button through an application in the mobile device, wherein the application is used to check the progress of the charging operation, and when the charging stop button is being pressed, the charging operation is stopped.

9. The method of claim 1, wherein the charging data at least comprises a charging time and a charging amount of power corresponding to the charging operation.

10. A charging management system for electric vehicles, comprising:
at least one electric vehicle charging station electrically coupled to an electric vehicle; and
a server connecting with the electric vehicle charging station via a network, receiving a charging request from the electric vehicle charging station or a mobile device via the network, in response to the charging request, transmitting a charging start instruction to the electric vehicle charging station via the network, and the electric vehicle charging station performs a charging operation to output power to the electric vehicle in response to the charging start instruction, wherein the electric vehicle is electrically coupled to the electric vehicle charging station, and the server enables the mobile device to have the ability to stop charging and determines whether the electric vehicle charging station stops outputting power to the electric vehicle, and the server disables the ability of stop charging of the mobile device when the electric vehicle charging station stops outputting power to the electric vehicle.

11. The system of claim 10, wherein the server further receives charging data corresponding to the charging operation from the electric vehicle charging station through the network, calculates a charging fee corresponding to the charging operation based on the charging data, determines whether the electric vehicle charging station has stopped being electrically coupled to the electric vehicle by the server, and calculates an occupancy fee and adds the occupancy fee to the charging fee when the electric vehicle charging station does not stop being electrically coupled to the electric vehicle.

12. The system of claim 11, wherein the server further generates billing information based on the charging fee and provides at least one payment mechanism to receive payment corresponding to the billing information when the electric vehicle charging station has stopped being electrically coupled to the electric vehicle.

13. The system of claim 10, wherein the server further receives a charging stop signal corresponding to stopping the charging operation from the mobile device through the network when the electric vehicle charging station does not stop outputting power to the electric vehicle, and in response to the charging stop signal, the server transmits a charging stop instruction to the electric vehicle charging station through the network, and the electric vehicle charging station stops the charging operation in response to the charging stop instruction.

14. The system of claim 13, wherein the server further receives charging data corresponding to the charging operation from the electric vehicle charging station through the network, and calculates a charging fee corresponding to the charging operation based on the charging data, and when the electric vehicle charging station stops the charging operation in response to the charging stop instruction, the server further sends a message to the mobile device through the network to notify that the charging operation has been stopped and will start counting an occupancy fee at a specific time point, determines whether the electric vehicle charging station has stopped being electrically coupled to the electric vehicle, and the server further calculates the occupancy fee and adds the occupancy fee to the charging fee when the electric vehicle charging station does not stop being electrically coupled to the electric vehicle.

15. The system of claim 14, wherein the server further generates billing information based on the charging fee and provides at least one payment mechanism to receive payment corresponding to the billing information when the electric vehicle charging station has stopped being electrically coupled to the electric vehicle.

16. The system of claim 10, wherein the server further enables the mobile device to have the ability to stop charging by sending a webpage link corresponding to the charging operation to the mobile device, and the webpage has a charging stop button, wherein when the charging stop button is being pressed, the charging operation is stopped.

17. The system of claim 10, wherein the server further enables the mobile device to have the ability to stop charging by providing a charging stop button through an application in the mobile device, wherein the application is used to check the progress of the charging operation, and when the charging stop button is being pressed, the charging operation is stopped.

18. The system of claim 10, wherein the charging data at least comprises a charging time and a charging amount of power corresponding to the charging operation.

19. A machine-readable storage medium comprising a computer program, which, when executed, causes a device to perform a charging management method for electric vehicles for use in a server connected to at least one first charging station via a network, wherein the method comprises:
receiving a charging request from the electric vehicle charging station or a mobile device via the network by the server;
in response to the charging request, transmitting a charging start instruction to the electric vehicle charging station via the network by the server, and performing a charging operation to output power to an electric vehicle in response to the charging start instruction by the electric vehicle charging station, wherein the electric vehicle is electrically coupled to the electric vehicle charging station;
enabling the mobile device to have the ability to stop charging by the server;
determining whether the electric vehicle charging station stops outputting power to the electric vehicle by the server; and
disabling the ability of stop charging of the mobile device by the server when the electric vehicle charging station stops outputting power to the electric vehicle.
